(19) United States
(12) Patent Application Publication
(10) Pub. No.: US 2002/0129591 A1
(43) Pub. Date: Sep. 19, 2002

(54) Crop stripper for the crop transport draper of a header

(76) Inventors: Roger L. Patterson, Selkirk (CA); Bruce Robert Kidd, Winnipeg (CA)

Correspondence Address: ADRIAN D. BATTISON, ADE & COMPANY, 1700 - 360 MAIN STREET, WINNIPEG, MB, R3C 3Z3, CA

(21) Appl. No.: 09/965,119

(22) Filed: Sep. 28, 2001

Related U.S. Application Data
(63) Continuation-in-part of application No. 09/810,425, filed on Mar. 19, 2001, now abandoned.

(51) Int. Cl. A01D 43/063; A01D 43/00

(52) U.S. Cl. 56/158

(57) ABSTRACT

A draper header for a combine harvester includes two side drapers each running from an outer end guide roller at a first end of the header to an inner end guide roller adjacent the discharge location of the header and a central feed draper located at the discharge location and including a front guide roller just behind the cutter bar and running to a rear guide roller in front of the feeder house of the combine harvester. Each inner end guide roller is associated with a respective discharge roller immediately adjacent and parallel to it with a stripper blade in contact with the peripheral surface of the discharge roller so as to strip the crop from the peripheral surface along the full length of the roller. Each stripper blade is inclined downwardly and inwardly to a bottom edge closely adjacent the upper run of the feed draper. The stripper roller or in another arrangement the draper itself has rows of projections across the surface which pass through corresponding shaped recesses in the edge of the stripper blade so that the crop material is discharged onto the blade while the projections are shaped to prevent the crop from being driven into the recesses. An auger is located between the discharge rollers with a front edge of the flight forward of the rear end of the discharge rollers to feed the material inwardly and underneath the auger to the inlet of the feeder house.

This application is a continuation-in-part Application from application Ser. No. 09/810425 filed Mar. 19, 2001.

This invention relates to header including a crop stripper for separating the crop from the transport draper of a crop harvesting header.

### BACKGROUND OF THE INVENTION

A header for a crop harvesting machine generally comprises a main longitudinal support member in the form of an elongate tube which extends across substantially the full width of the header frame and defines a main structural member for the header frame. The tube carries a plurality of forwardly and downwardly extending support beams which include a first portion extending downwardly and a second portion attached to a lower end of the first portion and extending forwardly therefrom toward a forward end of the support beams. The cutter bar is attached to the forward end of the support beams and is thus held thereby in a position generally parallel to the main support tube.

In U.S. Pat. No. 4,956,966 issued September 1990 and U.S. Pat. No. 5,005,3,43 issued April 1991 by Patterson and assigned to the present Assignee is disclosed a header which utilizes two side drapers to transport the crop cut by the knife inwardly along the header table to a central discharge opening. The side drapers discharge onto a central feed draper which has a front roller just behind the knife and a rear roller at the feeder house of a combine harvester so as to carry the crop from the side drapers rearwardly into the feeder house for inlet into the combine harvester for processing. A rotary feed member which may carry auger flight portions is mounted at the discharge opening of the header above the feed draper so as to assist in carrying bulky crop through the discharge opening so as to be carried into the feeder house. The feed draper is carried on the rear roller which is attached to a feeder house and therefore the feed draper and its associated underlying pan flex and twist as the header floats relative to the feeder house.

While this arrangement has achieved considerable commercial success, it is desirable to improve the feed of the crop material from the side drapers into the feeder house particularly in relation to bulky crops such as soy beans.

A subsequent U.S. patent which is U.S. Pat. No. 5,454,371 issued November 1995 by Honey discloses a similar arrangement in which the crop is transferred from the rear end of the feed draper into a rigid fixed adapter housing which is mounted on the front of the feeder house and contains the rotary feed member in the form of an auger with conventional feeding fingers. This arrangement therefore requires that the header is moved forwardly relative to the feeder house so as to provide the space necessary for the adapter housing and its rotary feed member contained therein.

In both patented arrangements there is significant difficulty in ensuring that the crop is effectively stripped from the drapers for transfer from the side drapers onto the feed draper to move rearwardly into the feeder house.

Further commercial devices are manufactured by Deere and Company and Agco but it is believed that there are no patents disclosing the construction of these devices.

While the present invention is primarily designed for use with a header of the above type for feeding the crop into the combine harvester, the same stripper arrangement as described in detail hereinafter can also be used in other arrangements where it is necessary to remove or strip crop from the end of a draper or conveyor.

### SUMMARY OF THE INVENTION

It is one object of the present invention to provide a header in which the system for transfer of crop from the side drapers to the feeder house is improved.

According to a first aspect of the invention there is provided a crop harvesting header for a combine harvester comprising:

a main frame structure extending across between two ends of the header across a width of the header for movement in a direction generally at right angles to the width across ground including a crop to be harvested;

a mounting assembly for carrying the main frame structure on the combine harvester;

a crop receiving table carried on the main frame structure across the width of the header;

a cutter bar across a front of the table carrying a cutter knife operable for cutting the crop as the header is moved forwardly across the ground for depositing the crop onto the table;

and a crop transport system for moving the cut crop toward a discharge location of the header for feeding the crop into a feed opening of the combine harvester;

the crop transport system including:

a first side draper having an outer end guide roller at a first end of the header, an inner end guide roller adjacent the discharge location and a continuous draper canvas wrapped around the outer and inner guide rollers to define a top run of the canvas for carrying the cut crop from the knife across the header to a discharge end adjacent the discharge location;

a second side draper having an outer end guide roller at a second end of the header, an inner end guide roller adjacent the discharge location and a continuous draper canvas wrapped around the outer and inner guide rollers to define a top run of the canvas for carrying the cut crop from the knife across the header to a discharge end adjacent the discharge location;

a feed draper located at the discharge location and including a front guide roller adjacent the cutter bar, a rear guide roller behind the front guide roller and a draper canvas wrapped around the front and rear guide rollers to define a top run of the feed draper for receiving the crop material from the discharge ends of the first and second side drapers and for carrying the crop material rearwardly toward the feed opening of the combine harvester;

a first discharge roller immediately adjacent to and parallel to the inner end guide roller of the first side draper and arranged to receive the crop therefrom to pass over a peripheral surface of the first discharge roller;

a first stripper blade having a stripper edge at the peripheral surface of the first discharge roller, the first stripper blade having a length substantially equal to the full length of the roller and a width to guide the stripped crop from the peripheral surface to the upper run of the feed draper;

a second discharge roller immediately adjacent to and parallel to the inner end guide roller of the second side draper and arranged to receive the crop therefrom to pass over a peripheral surface of the second discharge roller; and

a second stripper blade having a stripper edge at the peripheral surface of the second discharge roller, the second stripper blade having a length substantially equal to the full length of the roller and a width to guide the stripped crop from the peripheral surface to the upper run of the feed draper.

Preferably each discharge roller has a top edge lying substantially in a common plane with or more preferably slightly lower than the upper run of the canvas of the respective side draper.

Preferably the feed draper has side edges each of which is located inwardly of the respective discharge roller and each stripper blade is inclined downwardly and inwardly from the respective discharge roller so as drop the crop onto the upper run of the feed draper.

Preferably the side drapers each includes transverse slats and each discharge roller is spaced from the respective inner guide roller by a distance just to clear the slats.

Preferably, according to one important aspect, the peripheral surface of each discharge roller includes a generally cylindrical surface surrounding an axis of the roller with a plurality of raised projections thereon with each projection defining a raised portion having a greater radial distance from the axis than the cylindrical surface, the projections are arranged at axially spaced locations on the cylindrical surface leaving between the projections portions of the cylindrical surface which are not raised, the stripper edge of the stripper blade cooperates with the discharge roller having a plurality of axially spaced recesses therein with each recess being axially aligned with a respective one of the projections and with each recess being separated from the next by a portion of the stripper edge; and each recess is shaped such that rotation of the roller causes the corresponding projection to pass therethrough while said portions of the stripper edge are located at said portions of the peripheral surface of the roller to guide the stripped crop from the peripheral surface to the upper run of the feed draper.

Preferably each projection is shaped in a cross-section lying in a radial plane so as to define a leading surface, a trailing surface and an apex surface at a junction between the leading edge and the trailing edge and wherein the leading surface is shaped and arranged relative to the peripheral surface and the stripper blade such that, as the leading surface enters the respective recess through an outer surface of the blade, the leading surface defines an angle with the outer surface of the blade which is greater than 90 degrees.

Preferably the leading surface is shaped and arranged relative to the outer surface of the blade such that the whole or substantially the whole of the leading surface passes through the outer surface into the recess before the angle reaches ninety degrees.

Preferably the leading surface defines an angle relative to a line intersecting the axis of the roller and the apex which is greater than 30 degrees.

Preferably the leading surface and the trailing surface are substantially sides of a triangle having an angle therebetween greater than 60 degrees and more preferably of the order of 90 degrees.

Preferably there is provided a plurality of rows of projections with the projections of each row being axially spaced and axially aligned with the projections of the other row or rows.

Preferably the rows are arranged axially of the roller.

Preferably each projection has axially spaced sides which are shaped and arranged to closely match axially spaced sides of the recess such that the projection passes through the recess with only small clearances.

Preferably the axially spaced sides of the each projection are tapered outwardly and axially.

Preferably the leading surface and the trailing surface are substantially sides of a triangle having an angle therebetween greater than 60 degrees.

Preferably the side drapers each includes transverse slats and each discharge roller is spaced from the respective inner guide roller by a distance such that an outermost edge of the projections just clears an outermost edge of the slats.

It is a further object of the present invention to provide an improved header in which separation or stripping of the crop from the crop transport draper is improved.

According to a second aspect of the invention there is provided crop harvesting header comprising:

a main frame structure extending across between two ends of the header across a width of the header for movement in a direction generally at right angles to the width across ground including a crop to be harvested;

a mounting assembly for carrying the main frame;

and a crop transport system for moving the cut crop toward a discharge location of the header including:

a crop transport member having a peripheral surface over which the crop is carried arranged for movement of the peripheral surface in a crop transport direction;

the peripheral surface having a cylindrical surface from which the crop is to be discharged;

a stripper blade having a stripper edge at the cylindrical surface to strip the crop from the peripheral surface for discharge therefrom;

the cylindrical surface surrounding an axis with a plurality of raised projections thereon with each projection defining a raised portion having a greater radial distance from the axis than the cylindrical surface,

the projections being arranged at axially spaced locations on the cylindrical surface leaving between the projections portions of the cylindrical surface which are not raised,

the stripper edge of the stripper blade having a plurality of axially spaced recesses therein with each recess being axially aligned with a respective one of the projections and with each recess being separated from the next by a portion of the stripper edge;

each recess being shaped such that rotation of the cylindrical surface about the axis causes the corresponding projection to pass therethrough while said portions of the stripper edge are located at said portions of the peripheral surface to guide the stripped crop from the peripheral surface.

According to a third aspect of the invention there is provided crop harvesting header comprising:

a main frame structure extending across between two ends of the header across a width of the header for movement in a direction generally at right angles to the width across ground including a crop to be harvested;

a mounting assembly for carrying the main frame;

and a crop transport system for moving the cut crop toward a discharge location of the header including:

a draper having two end guide rollers and a continuous draper canvas wrapped around the guide rollers to define a top run of the canvas for carrying the cut crop;

a discharge roller immediately adjacent to and parallel to one end guide roller of the draper and arranged to receive the crop therefrom to pass over a peripheral surface of the first discharge roller;

the roller having a cylindrical surface from which the crop is to be discharged;

a stripper blade having a stripper edge at the cylindrical surface to strip the crop from the roller for discharge therefrom;

the cylindrical surface surrounding an axis of the roller with a plurality of raised projections thereon with each projection defining a raised portion having a greater radial distance from the axis than the cylindrical surface,

the projections being arranged at axially spaced locations on the cylindrical surface leaving between the projections portions of the cylindrical surface which are not raised,

the stripper edge of the stripper blade having a plurality of axially spaced recesses therein with each recess being axially aligned with a respective one of the projections and with each recess being separated from the next by a portion of the stripper edge;

each recess being shaped such that rotation of the cylindrical surface about the axis causes the corresponding projection to pass therethrough while said portions of the stripper edge are located at said portions of the cylindrical surface to guide the stripped crop from the cylindrical surface.

According to a fourth aspect of the invention there is provided a crop harvesting header comprising:

a main frame structure extending across between two ends of the header across a width of the header for movement in a direction generally at right angles to the width across ground including a crop to be harvested;

a mounting assembly for carrying the main frame;

and a crop transport system for moving the cut crop toward a discharge location of the header including:

a draper having two end guide rollers and a continuous draper canvas wrapped around the guide rollers to define a top run of the canvas for carrying the cut crop;

the canvas at one end roller having a cylindrical surface from which the crop is to be discharged;

a stripper blade having a stripper edge at the cylindrical surface to strip the crop from the roller for discharge therefrom;

the cylindrical surface surrounding an axis of the roller with a plurality of raised projections thereon with each projection defining a raised portion having a greater radial distance from the axis than the cylindrical surface,

the projections being arranged at axially spaced locations on the cylindrical surface leaving between the projections portions of the cylindrical surface which are not raised,

the stripper edge of the stripper blade having a plurality of axially spaced recesses therein with each recess being axially aligned with a respective one of the projections and with each recess being separated from the next by a portion of the stripper edge;

each recess being shaped such that rotation of the cylindrical surface about the axis causes the corresponding projection to pass therethrough while said portions of the stripper edge are located at said portions of the cylindrical surface to guide the stripped crop from the cylindrical surface.

### BRIEF DESCRIPTION OF THE DRAWINGS

One embodiment of the invention will now be described in conjunction with the accompanying drawings in which:

FIG. 1 is a top plan view of the center section only of a header according to the present invention with a number of elements such as the reel omitted for convenience of illustration.

FIG. 2 is a cross sectional view along the lines 2-2 of the header of FIG. 1.

FIG. 2A is a cross sectional view along the lines 2A-2A of the header of FIG. 1.

FIG. 3 is an isometric view of the inner end of the side draper and its associated stripper roller and stripper blade of the header of FIG. 1.

FIG. 4 is a cross sectional view along the lines 4-4 of FIG. 2.

FIG. 5 is a top plan view of the complete header of FIG. 1 with a number of elements such as the reel omitted for convenience of illustration.

FIG. 6 is an isometric view of the center section of the header of FIG. 1 looking rearwardly toward the feeder house.

FIG. 7 is a cross-sectional view similar to that of FIG. 4 showing a second embodiment of stripper arrangement for separating the crop from the end of the side draper.

FIG. 8 is a top plan view of the embodiment of FIG. 7.

FIGS. 9 and 10 are scrap views of the roller and stripper blade of FIG. 7 showing the movement of the projections relative to the stripper blade.

FIG. 11 is a cross-sectional view similar to that of FIG. 4 showing a third embodiment of stripper arrangement for separating the crop from the end of the side draper.

FIG. 12 is a top plan view of the embodiment of FIG. 11.

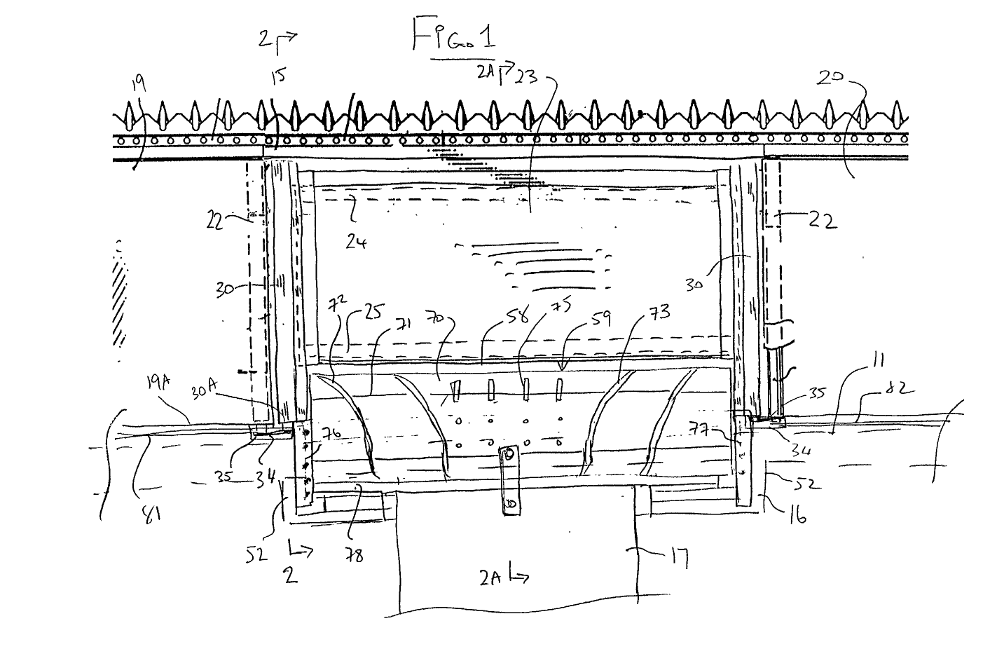

In the drawings like characters of reference indicate corresponding parts in the different figures.

### DETAILED DESCRIPTION

The header shown in the figures comprises a main frame 10 including a horizontal main support beam 11 extending along the length of the header along a first end 12 to a second end 13 of the header. The main frame includes forwardly extending frame members 14 at the ends of the header together with similarly arranged frame members intermediate the width of the header. At the front end of the frame members is mounted a cutter bar 15 which carries a sickle knife construction of a conventional nature. The frame 10 is attached to an adapter structure 16 attached to the feeder house 17 of a combine harvester 18.

The header includes a crop transportation system for transferring the crop from the sickle knife to the feeder house. This includes two side drapers 19 and 20 each of which includes a canvas extending from an outer guide roller 21 to an inner guide roller 22 so as to define an upper run of the canvas which carries the crop inwardly toward the center of the header.

At the center of the header is provided a feed draper 23 which has a front roller 24 just behind the cutter bar and a rear roller 25 thus defining an upper run of the canvas which carries the crop rearwardly toward the feeder house.

Headers of the general type described above are well known and the area with which the present invention is concerned is that of the feed section at the center of the header which carries the crop from the inner ends of the side drapers into the feeder house.

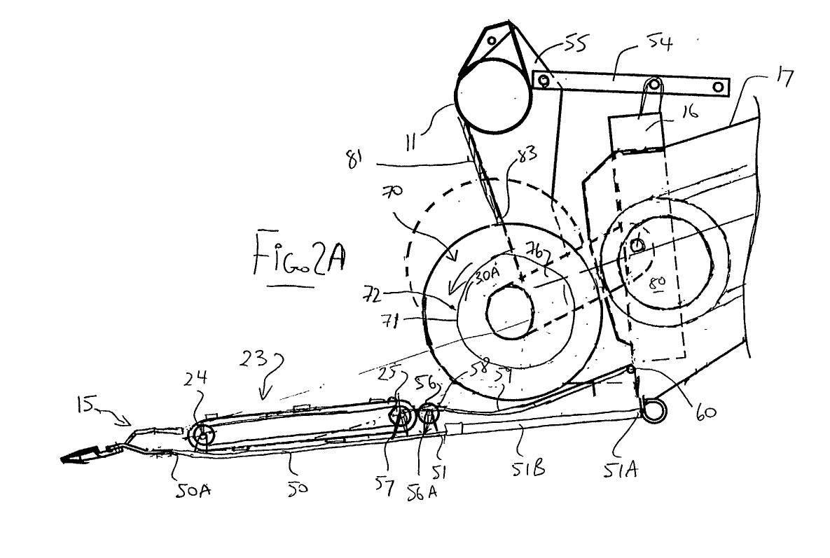

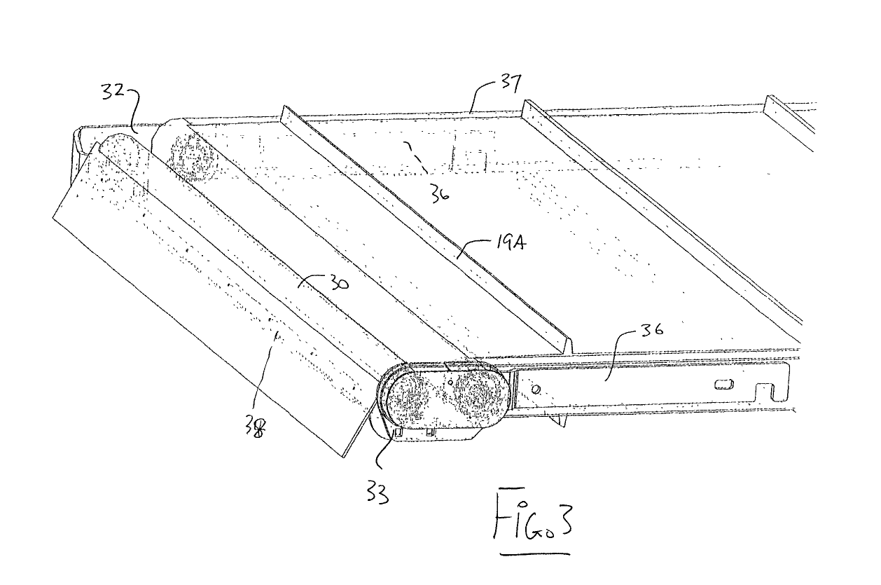

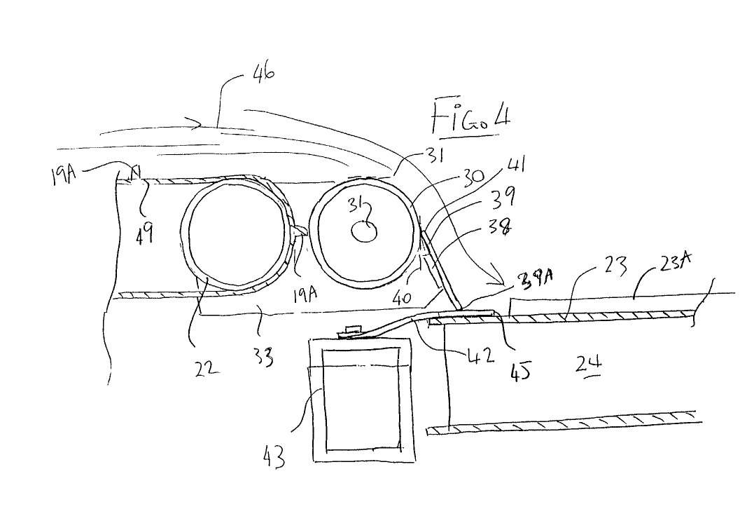

As shown in FIGS. 3 and 4, a first improvement in the central feeding area comprises a stripping system for stripping the crop material so that it is properly deposited on the upper run of the feed draper 23. The stripping system comprises a stripper roller 30 which has a smooth outer surface with an upper tangent 31 lying in a common plane with the top run of the draper 19, 20. The roller 30 has a diameter approximately equal to the diameter of the roller 22 of the draper. The canvas of the draper carries a plurality of transverse slats 19A and the roller 30 is spaced from the roller 22 by a distance so that the slats just clear the surface of the roller 30 as the slats pass through the space between the roller 22 and the roller 30.

The roller 30 is carried on end shaft portions 31 which project through end support plates 32 and 33. At the rear end of the rollers 30 is provided a housing 34 within which is provided a chain drive 35 for driving the roller 340 at the same angular speed as the roller 22. Each of the support plates 32 is carried on a respective one of a pair of support brackets 36 which are attached to the front and rear support rails 37 respectively of the respective draper. Thus the rollers 30 are supported at the inner ends of the drapers and are located inwardly of the end roller of the draper in a common plane with the draper.

Each support plate 32, 33 carries a blade support bar 38 which extends across between the plates 32 and 33 and underneath the roller 30. The blade support 34 is positioned so that it can receive a stripper blade 39. The angle of the bar 38 is arranged so that the stripper blade 39 when attached thereto extends from the innermost tangent 40 of the stripper roll downwardly and inwardly over the surface of the upper run of the feed draper 23. An upper edge 41 of the blade brushes against the peripheral surface of the roller so that material passing over the roller 30 is swept off the surface of the roller and runs over the blade 39.

A side guard blade 42 is mounted at its outer edge on a support frame member 43 of the header so that the blade 42 extends inwardly over the top of the upper run of the draper 23 to a position inward of a lower edge 43 of the blade 39. The blade 39 thus extends downwardly onto the upper surface of the blade 42 so that there is no rubbing of the bottom edge 43 of the stripper blade on the draper. The blades 39 and 42 are cut to a length so that they close off any space between the stripper roller 30 and the draper 23. As the space between the draper 23 and the stripper roller can vary along the length of the draper 23. The blades, 39 and 42 are shaped to accommodate this change in space. The draper 23 carries slats 23A with ends of the slats arranged just inside the inner edge 45 of the blade 42.

Thus the header is improved so that the crop material 46 carried over the end roller 22 of the draper by the draper passes over the stripper roller 30 and cannot penetrate between the rollers 22 and 30 due to the close proximity between those rollers.

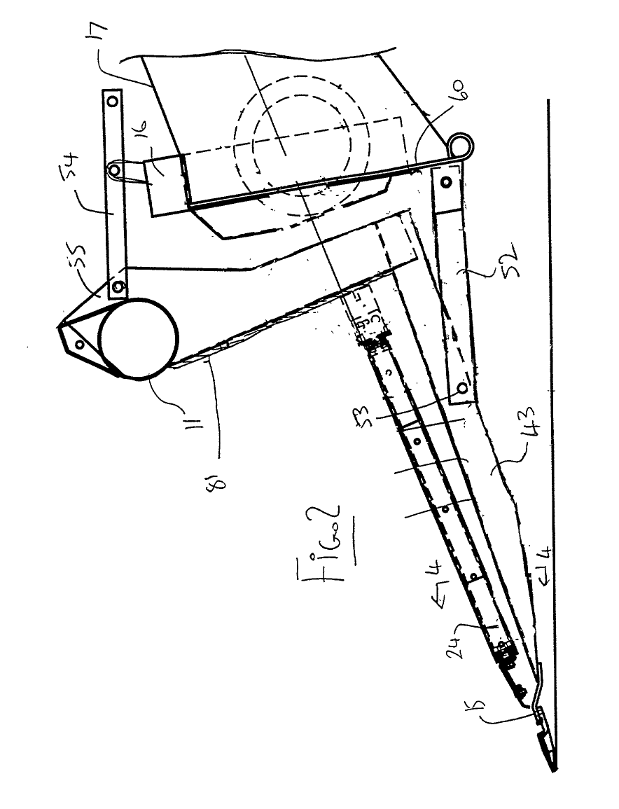

Turning now to FIGS. 2 and 2A, it will be noted that the front roller 24 of the feed draper 23 is carried on a support immediately rearward of the cutter bar 15 so that it is fixed to the forward edge of the header. The rear roller 25 is carried on a bracket 57 mounted on a support pan 50 which extends from the header at a forward end 50A at the cutter bar 15 at the front of and inwardly of the support frame member 43 rearwardly to a rear end 51. At the rear end 51 of the pan is provided a pair of side arms 51 B which extend from the rear edge of the pan on respective sides of the pan to a rear end 51A carried on the adapter 16 attached to the feeder house 17. An open space is thus defined between the arms.

The header including the main beam 11 and the frame element 43 is carried on the support frame 16 by two bottom links 52 which extend forwardly from the frame 16 under the header frame within a respective one of the arms 43 and support the header frame at a forward end 53 of the links 52. The links are supported on mounting springs (not shown). A top support link 54 extends forwardly from the frame 16 to a bracket 55 at the beam 11. Thus the header can move upwardly and downwardly in a floating action and can also twist side to side about a generally horizontal forwardly extending axis by a differential in the lifting of the links 52.

Thus the support pan 50 for the feed draper has its forward end attached to the header and its rearward end attached to the frame 16 so that it is necessary for the pan to flex and twist to accommodate the floating and pivoting action of the header. The rear roller 25 of the draper 23 is thus mounted on the pan 50 and therefore also the draper 23 flexes and twists to accommodate such movement.

At the rear roller 25 on the bracket 57 of the pan 50 is mounted an optional stripper roller 56 carried on a bracket 56A. The stripper roller, if provided, operates similarly to the rollers 30 to strip the crop material from the draper 23 to prevent it from being carried under the draper. Immediately behind the stripper roller 56 is provided a forward end 58 of a guide sheet 59 which extends from the stripper roller 56, or if not provided, from the rear end of the draper 23 rearwardly to a rear end 60 at the feeder house. Thus the rear end 60 carried on the frame 16 at the feeder house and the front end 58 is carried on the bracket 57 so that the sheet 59 also flexes and twists to accommodate the movement of the header. The sheet edge 58 may contact the stripper roller in a stripping action.

The sheet 59 has a width substantially equal to the width of the draper 23 so that the material discharged from the draper across the full width of the draper is carried rearwardly over the sheet to the feeder house.

The movement of the crop material to the feeder house is assisted by a rotary feed member 70 carried above the sheet 59 with a width substantially equal to the width of the sheet 59. The rotary feed member 70 includes a drum 71 which carries on its outside surface two helical auger sections 72 and 73 arranged at respective ends of the drum and arranged so that rotation of the drum in a counter clockwise direction so as to carry the crop material underneath the rotary feed member across the sheet 59 causes the crop material at the side edges of the sheet to be drawn inwardly toward a center of the sheet. At the center of the drum 71 is provided a plurality of fingers or other projecting members as indicated at 75 which direct the crop material rearwardly to enter the feeder house 17. Thus it will be noted that the rotary feed member is wider than the feeder house. The rotary feed member has a length so that it fits just inside the stripper rollers 30. The rotary feed member has a diameter so that its forward edge substantially directly overlies the rear edge of the feed draper and the forward edge of the sheet 59 so that it can pick up material from the rear of the draper and carry that material rearwardly. Thus the forward edge of the rotary feed member projects to a position forward of a rear edge 30A of a stripper roller and forward of a rear edge 19A of the draper.

The rotary feed member is carried on two side arms 76 and 77 which are mounted at their rear end on a transverse shaft 78 carried on the frame 16. The shaft 78 is positioned just in front of the front feeder chain pulley 80 so that the position of the rotary feed member 70 is maintained substantially constant relative to the feeder chain as the rotary feed member pivots upwardly and downwardly on the shaft 78 to accommodate changes in thickness of the crop on top of the sheet 59.

The rear of the header is defined by two rear sheets 81 and 82 on respective sides of the header which define an opening 83 at the rotary feed member so that the rotary feed member projects through the opening to operate in co-operation with the sheet 59 in the area at the rear of the header and on top of the sheet 59. Thus the position of the rotary feed member is such that it is behind the front of the header and forward of the rear part of the header and sits intermediate the rear wall of the header. The header is thus moved as far back close to the frame 16 as is physically possible and this positioning of the header is not influenced by the location of the rotary feed member. In addition the rotary feed member is of a size so that it can cooperate with the sheet 59 in properly feeding the crop material into the feeder house. It is also located in a position so that it co-operates with a feeder chain at all times during its operation and during its movement. Stops may be provided to prevent the rotary feed member from engaging the sheet 59 which could cause damage.

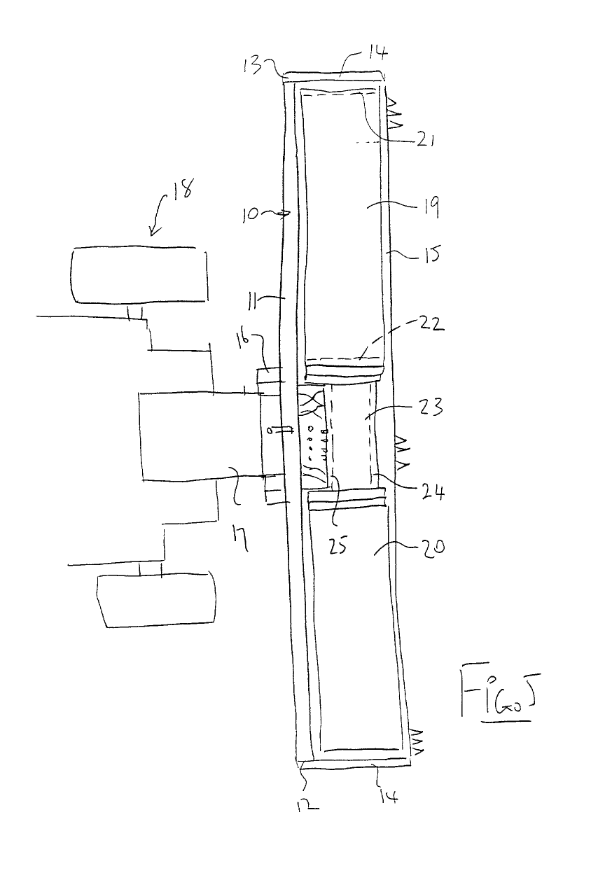

FIG. 6 shows a modified arrangement in which the draper 23 extends to the feeder house and the stripper roller 56 and the pan 59 are omitted. Thus in this case the feed member 70 co-operates with the upper run of the draper in feeding the material into the feeder house.

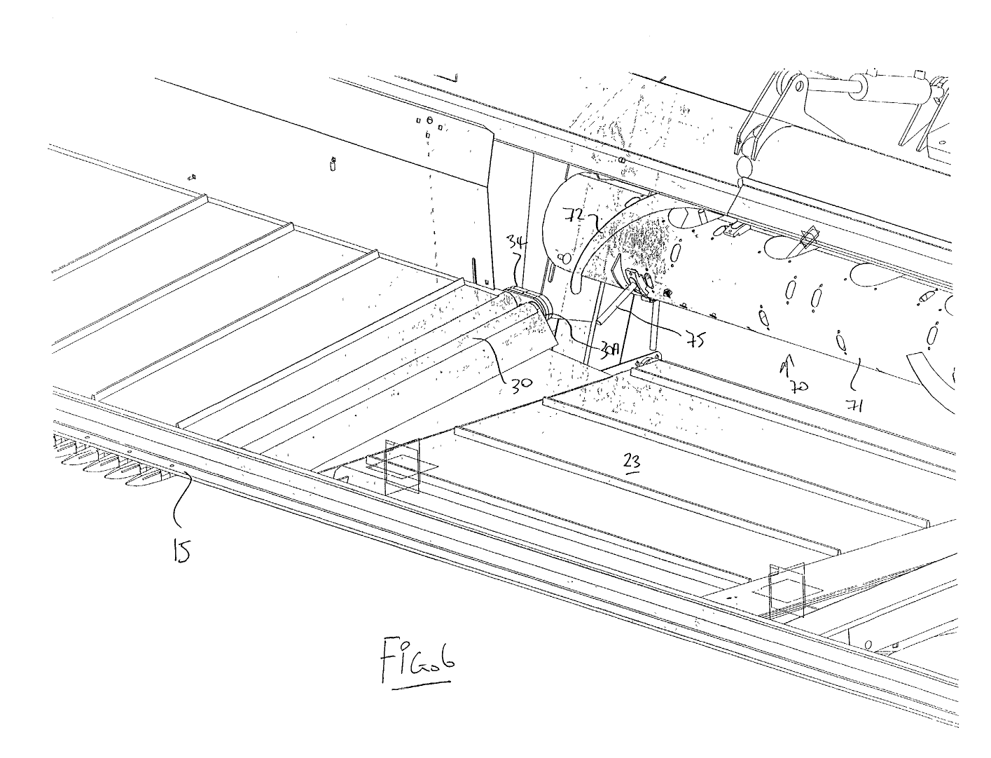

Turning now to the embodiment shown in FIGS. 7 through 10, there is shown a stripper roller arrangement including a stripper roller 301 which is located at the same position as the roller 30 in the embodiment shown in FIG. 4 and operates in basically the same manner but is modified to provide an improved stripping action.

Thus the roller 301 co-operates with a stripper blade 391 in the manner previously described to strip the crop material from the stripper roller 301 and to carry it onto the feed draper as previously described. The roller 301 is modified so that it includes two rows 302 and 303 of projections 304. The rows extend axially along the roller parallel to the axis 305 of the roller and in the embodiment shown there are two such rows arranged diametrically opposed on the surface of the roller 301. The projections are spaced apart axially so as to leave a portion 306 of the peripheral surface 307 of the roller between each projection and the next so that the roller is basically cylindrical in shape defining the peripheral surface 307 with the projections extending outwardly from the peripheral surface to a raised height above the surface. The projections have side walls 308 and 309 spaced axially along the roller and those sidewalls are, in the example shown, planar and tapered upwardly and outwardly from the surface 307. Sidewalls can also be directly parallel so as to lie in radial planes of the axis of the roller. Also in another preferred arrangement, the side walls may have a first portion at the roller which is parallel and a second portion outward therefrom which is tapered since it is preferred to have them slightly tapered as shown so that the base of the projection is larger than the top of the projection to provide an improved anchoring of the structure of the projection to the surface 307.

In the embodiment shown the projections are formed as bent sheet metal tabs generally of V shape in side elevational view as shown in FIG. 7 with the tabs thus forming a leading surface 310, a trailing surface 311 and an apex 312. The base of the legs defining the leading and trailing surfaces is attached at 313 to the surface of the roller.

In an alternative arrangement (not shown) the projections can be formed as molded elements integrally molded with the wall forming the surface 307 and molded from a suitable plastics or resilient material.

In the embodiment shown there are two such rows of projections but it will be appreciated that additional rows can also be provided at angularly spaced positions around the roller.

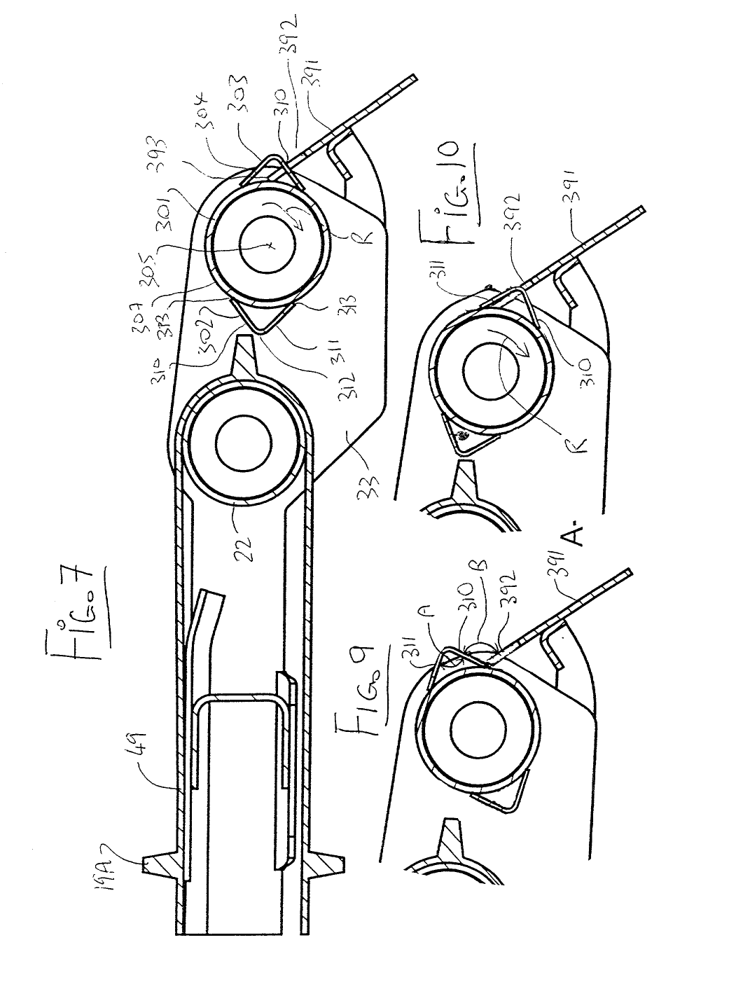

The projections of each row are axially aligned with the projections of the next row so that the number and axial position of the projections is identical for the rows allowing those aligned projections to co-operate with correspondingly shaped recesses 392 in the blade 391. Thus as shown in FIG. 8, the blade 391 has a stripping edge 393 which is at or in contact with the surface 307 to provide a stripping action. That stripping edge 393 has a plurality of recesses 392 each shaped so that the aligned projections 304 can just pass through that recess as the roller rotates in the stripping direction R. Thus the recesses have side walls 394 and 395 which match the side walls 308 and 309 of the projections, as defined above, and are therefore in the embodiment shown tapered inwardly toward one another from the stripping edge toward the bottom of the blade. The recesses further have a base 396 which matches the width of the apex 312 of the projections.

As shown in the side elevation of FIG. 7, the roller is mounted on the end bracket 33 so that the roller is located at a spacing from the end guide roller 22 at the draper sufficient that the apex 312 just clears the top of the slats 19A of the draper. In most embodiments it is not practical to provide accurate timing between the slats and the draper and the projections on the roller so that it is simply assumed it is possible that the slats and the projections may pass one another apex to apex and therefore the spacing is set up to provide clearance at that position to allow them to pass, should that occur.

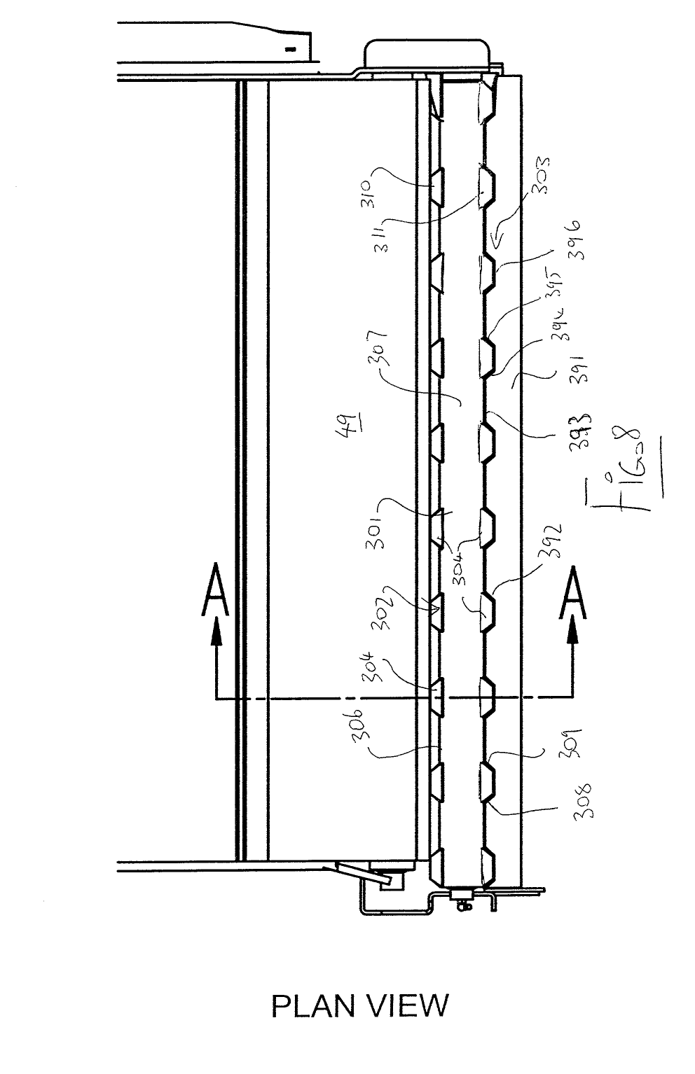

As shown in FIG. 9, the projections are shaped so that the angle between the leading surface 310 and the trailing surface 311 indicated at angle A is at the order of 90° and is preferably greater than 60°. This provides a projection which is relatively wide and shallow with the leading edge arranged at an angle to the axial plane at the order of 45°. It will be appreciated that this relatively shallow angle relative to the radial plane reduces the aggression of action of the leading surface but it has been found that an angle of the order of 60° or greater provides a sufficiently aggressive action on the crop material so that the projections and particularly the leading surface of the projections as they pass upwardly between the draper and the roller 301 act to lift the crop off the slats and over the gap between the draper and the roller thus acting to carry the crop and strip the crop from the draper so that it is transported over the roller for discharge.

While a bare cylindrical roller without such projections can act to carry the crop in certain conditions, some crop conditions and crop materials in the absence of the projections can be forced by the slats to enter the space between the draper and the stripper roller so as to force crop material into that space and cause blockages. The provision of the projections ensures that this does not occur and causes all crop material to be lifted from the draper, separated from the slats and carried over the stripper roller.

The stripper blade 391 extends from the stripper edge 393 at the surface 307 of the roller downwardly and inwardly as shown in FIGS. 7, 9 and 10 for discharge at the bottom end of the blade. In order to allow the projections to pass through the blade while allowing the strip edge 393 to rest at the surface 307, the recesses are provided and it is important to ensure that the projections are shaped and arranged relative to the blade so that the projections themselves do not cause crop material to be forced through those recesses which again would cause blockages.

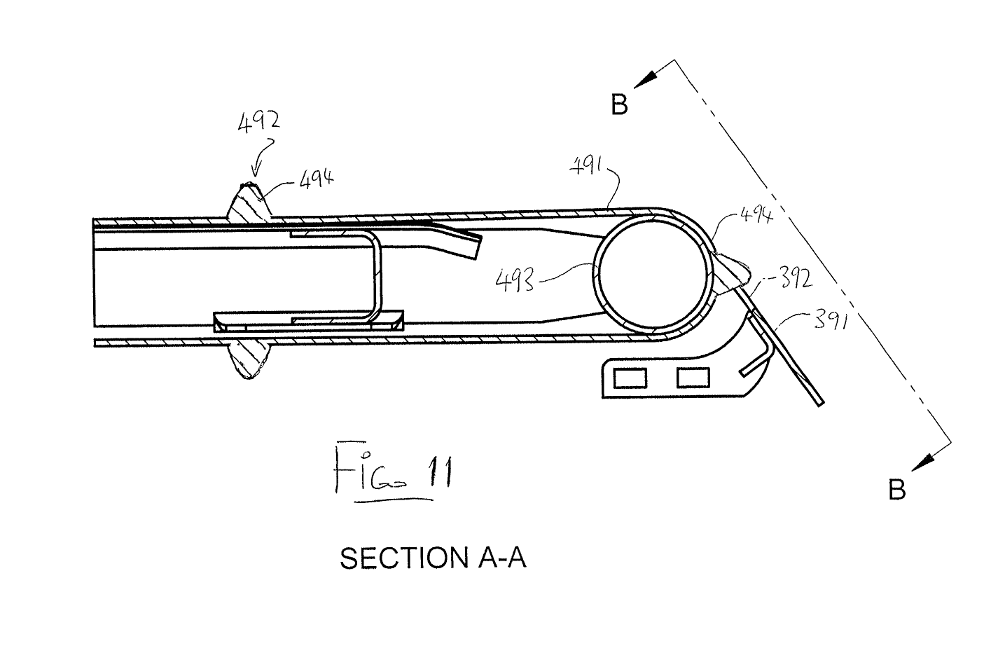

For this reason the relatively shallow angle of the leading surface 310 is selected so that the angle of attack of the leading surface is the least aggressive which can be accepted while still acting to strip material at the draper. This shallow angle as shown in comparing FIGS. 9, 7 and 10 in that order shows the passage of the leading surface 310 and the apex 312 through the recess in the blade 391. It will be noted in FIG. 9 that the leading surface as it is initially commences to pass through the recess at the base of the projection is arranged at an angle B relative to the outwardly facing surface of the blade 391 which angle B is greater than 90°. As the leading surface 310 continues to pass through the recess as shown in FIG. 7, the leading surface 310 remains at an angle greater than 90° for the majority of the distance of movement of the leading surface into the recess. Thus in FIG. 7 where most of the leading surface has already passed through the recess, the angle of the leading surface relative to the blade approaches 90°. It will be appreciated that, when the leading surface 310 is at right angles to the blade 391 there is substantially no force on the crop tending to push the crop into the recess 392. Only when the leading surface is at an angle so that the angle B is less than 90° to the surface 392 is there a force tending to push the crop material into the recess which could cause pinching of the crop between the projection and the recess. The angle of the blade and the angle of the leading edge is therefore arranged so that the angle B passes to a position less than 90° only at or when the projection is substantially wholly through the recess as shown in FIG. 10. It will be appreciated that this condition can be obtained by providing a shallow angle of the leading surface 310 as shown or by reducing the angle to the vertical of the blade 391. The angles as shown where the projection is triangular with approximately 90° between the leading and trailing surfaces and where the angle of the blade to the vertical of the order of 35° provides an operating arrangement which avoids the crop from being pushed through the recesses and pinched between the projection and the recess. However it will be appreciated that minor changes to these angles can be used if necessary to increase the aggressive angle of the leading surface and by reducing the inward incline of the blade. However it is undesirable to decrease the angle A to an angle less than 60°.

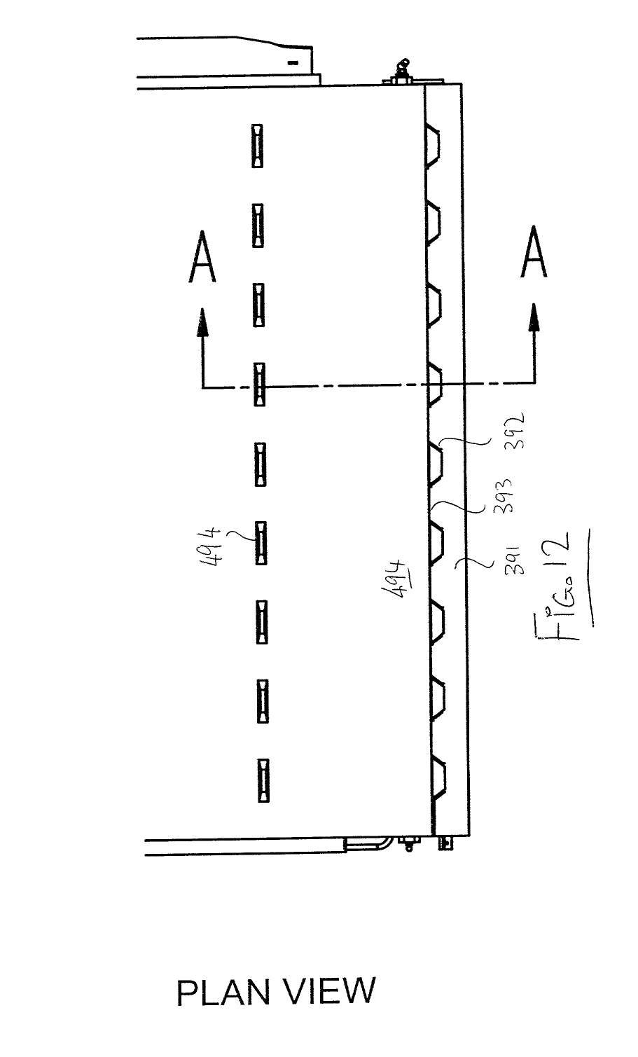

Turning now to FIGS. 11 and 12 there is shown a further modified arrangement in which the roller 301 is omitted and the blade 391 is arranged to cooperate directly with the cylindrical portion of the draper 491 and the slats 492. Thus the draper 491 is wrapped around the cylindrical surface of the end guide roller 493 to provide a cylindrical surface 494 against which the edge 393 of the blade 391 is located to provide a stripping action.

In this embodiment the slats 492 are modified so that each slat is defined by a row of projections 494. The projections 494 are again arranged in axially spaced rows so that projections of each slat 492 are aligned with the projections of the next 492 and aligned with the recesses 392. The projections 494 are shaped as previously described in the embodiment of FIG. 7 so that the leading surface, the apex and the trailing surface provide a triangular shape which co-operates with the blade and the opening 392 as previously described to allow the leading surface to pass through the blade without forcing crop material into the opening 392. Thus the stripping blade 391 co-operates directly with the end roll of the draper in an effective stripping action while the slats are shaped and arranged so that they provide the necessary transport action conventional and in draper canvas while the slats avoid interfering with the stripping action of the blade by the cooperation of the projecting portions define the slats with the recesses 392 of the blade.

In order to ensure that the aligned projections remain in proper alignment with the recesses in the blades, it is desirable to accurately maintain the draper canvas in a tracking path and one suitable arrangement for guiding the draper in this movement is described in U.S. application Ser. No. 09/590,128 filed Jun. 9, 2000 by Shearer and assigned to the present applicant. This application corresponds to Canadian application 2,311,019 filed Jun. 8, 2000.

In view of the reduced degree of stiffness provided by the slats since those slats are now formed by individual axially spaced projection, it is desirable to provide additional support for the draper canvas at spaced positions along the length of the draper canvas. It is also necessary to provide a connecting element for the ends of the draper canvas which does not project upwardly from the draper canvas to interfere with the blade 391. Continuous draper canvasses are commercially available or alternative coupling elements can be provided which connect the ends of the draper canvas without providing an outwardly projecting bar. Thus the only outward projection from the draper canvas as it moves past the blade is provided by the projections forming the slats so that the stripping blade can provide an effective stripping action with the stripping edge at or in contact with the surface 494.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A crop harvesting header for a combine harvester comprising:
a main frame structure extending across between two ends of the header across a width of the header for movement in a direction generally at right angles to the width across ground including a crop to be harvested;
a mounting assembly for carrying the main frame structure on the combine harvester;
a crop receiving table carried on the main frame structure across the width of the header;
a cutter bar across a front of the table carrying a cutter knife operable for cutting the crop as the header is moved forwardly across the ground for depositing the crop onto the table;
and a crop transport system for moving the cut crop toward a discharge location of the header for feeding the crop into a feed opening of the combine harvester;
the crop transport system including:
a first side draper having an outer end guide roller at a first end of the header, an inner end guide roller adjacent the discharge location and a continuous draper canvas wrapped around the outer and inner guide rollers to define a top run of the canvas for carrying the cut crop from the knife across the header to a discharge end adjacent the discharge location;
a second side draper having an outer end guide roller at a second end of the header, an inner end guide roller adjacent the discharge location and a continuous draper canvas wrapped around the outer and inner guide rollers to define a top run of the canvas for carrying the cut crop from the knife across the header to a discharge end adjacent the discharge location;
a feed draper located at the discharge location and including a front guide roller adjacent the cutter bar, a rear guide roller behind the front guide roller and a draper canvas wrapped around the front and rear guide rollers to define a top run of the feed draper for receiving the crop material from the discharge ends of the first and second side drapers and for carrying the crop material rearwardly toward the feed opening of the combine harvester;
a first discharge roller immediately adjacent to and parallel to the inner end guide roller of the first side draper and arranged to receive the crop therefrom to pass over a peripheral surface of the first discharge roller;
a first stripper blade having a stripper edge at the peripheral surface of the first discharge roller, the first stripper blade having a length substantially equal to the full length of the roller and a width to guide the stripped crop from the peripheral surface to the upper run of the feed draper;
a second discharge roller immediately adjacent to and parallel to the inner end guide roller of the second side draper and arranged to receive the crop therefrom to pass over a peripheral surface of the second discharge roller; and
a second stripper blade having a stripper edge at the peripheral surface of the second discharge roller, the second stripper blade having a length substantially equal to the full length of the roller and a width to guide the stripped crop from the peripheral surface to the upper run of the feed draper.

2. The header according to claim 1 wherein each discharge roller has a top edge lying substantially in a common plane with or slightly lower than the upper run of the canvas of the respective side draper.

3. The header according to claim 1 wherein each stripper blade extends generally downwardly from the respective discharge roller so as drop the crop onto the upper run of the feed draper.

4. The header according to claim 1 wherein each stripper blade is inclined downwardly and inwardly from the respective discharge roller so as drop the crop onto the upper run of the feed draper.

5. The header according to claim 1 wherein the feed draper has side edges each of which is located inwardly of the respective discharge roller.

6. The header according to claim 5 wherein each stripper blade is inclined downwardly and inwardly from the respective discharge roller so as drop the crop onto the upper run of the feed draper.

7. The header according to claim 1 wherein the side drapers each includes transverse slats and each discharge roller is spaced from the respective inner guide roller by a distance just to clear the slats.

8. The header according to claim 1 wherein
the peripheral surface of each discharge roller includes a generally cylindrical surface surrounding an axis of the roller with a plurality of raised projections thereon with each projection defining a raised portion having a greater radial distance from the axis than the cylindrical surface,
the projections being arranged at axially spaced locations on the cylindrical surface leaving between the projections portions of the cylindrical surface which are not raised,
the stripper edge of the stripper blade cooperating with the discharge roller having a plurality of axially spaced recesses therein with each recess being axially aligned with a respective one of the projections and with each recess being separated from the next by a portion of the stripper edge;
each recess being shaped such that rotation of the roller causes the corresponding projection to pass therethrough while said portions of the stripper edge are located at said portions of the peripheral surface of the roller to guide the stripped crop from the peripheral surface to the upper run of the feed draper.

9. The header according to claim 8 wherein each projection is shaped in a cross-section lying in a radial plane so as to define a leading surface, a trailing surface and an apex surface at a junction between the leading edge and the trailing edge and wherein the leading surface is shaped and arranged relative to the peripheral surface and the stripper blade such that, as the leading surface enters the respective recess through an outer surface of the blade, the leading surface defines an angle with the outer surface of the blade which is greater than 90 degrees.

10. The header according to claim 9 wherein the leading surface is shaped and arranged relative to the outer surface of the blade such that the whole or substantially the whole of the leading surface passes through the outer surface into the recess before the angle reaches ninety degrees.

11. The header according to claim 9 the leading surface defines an angle relative to a line intersecting the axis of the roller and the apex which is greater than 30 degrees.

12. The header according to claim 9 wherein the leading surface and the trailing surface are substantially sides of a triangle having an angle therebetween greater than 60 degrees.

13. The header according to claim 9 wherein the leading surface and the trailing surface are substantially sides of a triangle having an angle therebetween of the order of 90 degrees.

14. The header according to claim 8 wherein there is provided a plurality of rows of projections with the projections of each row being axially spaced and axially aligned with the projections of the other row or rows.

15. The header according to claim 14 wherein the rows are arranged axially of the roller.

16. The header according to claim 8 wherein each projection has axially spaced sides which are shaped and arranged to closely match axially spaced sides of the recess such that the projection passes through the recess with only small clearances.

17. The header according to claim 16 wherein the axially spaced sides of the each projection are tapered outwardly and axially.

18. The header according to claim 9 wherein the leading surface and the trailing surface are substantially sides of a triangle having an angle therebetween greater than 60 degrees.

19. The header according to claim 8 wherein the side drapers each includes transverse slats and each discharge roller is spaced from the respective inner guide roller by a distance such that an outermost edge of the projections just clears an outermost edge of the slats.

20. A crop harvesting header comprising:
a main frame structure extending across between two ends of the header across a width of the header for movement in a direction generally at right angles to the width across ground including a crop to be harvested;
a mounting assembly for carrying the main frame;
and a crop transport system for moving the cut crop toward a discharge location of the header including:
a crop transport member having a peripheral surface over which the crop is carried arranged for movement of the peripheral surface in a crop transport direction;
the peripheral surface having a cylindrical surface from which the crop is to be discharged;
a stripper blade having a stripper edge at the cylindrical surface to strip the crop from the peripheral surface for discharge therefrom;
the cylindrical surface surrounding an axis with a plurality of raised projections thereon with each projection defining a raised portion having a greater radial distance from the axis than the cylindrical surface,
the projections being arranged at axially spaced locations on the cylindrical surface leaving between the projections portions of the cylindrical surface which are not raised,
the stripper edge of the stripper blade having a plurality of axially spaced recesses therein with each recess being axially aligned with a respective one of the projections and with each recess being separated from the next by a portion of the stripper edge;
each recess being shaped such that rotation of the cylindrical surface about the axis causes the corresponding projection to pass therethrough while said portions of the stripper edge are located at said portions of the peripheral surface to guide the stripped crop from the peripheral surface.

21. The header according to claim 20 wherein each stripper blade is inclined downwardly and away from the discharge end.

22. The header according to claim 20 wherein each projection is shaped in a cross-section lying in a radial plane so as to define a leading surface, a trailing surface and an apex surface at a junction between the leading edge and the trailing edge and wherein the leading surface is shaped and arranged relative to the peripheral surface and the stripper blade such that, as the leading surface enters the respective recess through an outer surface of the blade, the leading surface defines an angle with the outer surface of the blade which is greater than 90 degrees.

23. The header according to claim 22 wherein the leading surface is shaped and arranged relative to the outer surface of the blade such that the whole or substantially the whole of the leading surface passes through the outer surface into the recess before the angle reaches ninety degrees.

24. The header according to claim 22 wherein the leading surface defines an angle relative to a line intersecting the axis of the roller and the apex which is greater than 30 degrees.

25. The header according to claim 22 wherein the leading surface and the trailing surface are substantially sides of a triangle having an angle therebetween greater than 60 degrees.

26. The header according to claim 22 wherein the leading surface and the trailing surface are substantially sides of a triangle having an angle therebetween of the order of 90 degrees.

27. The header according to claim 20 wherein there is provided a plurality of rows of projections with the projections of each row being axially spaced and axially aligned with the projections of the other row or rows.

28. The header according to claim 27 wherein the rows are arranged axially of the cylindrical surface.

29. The header according to claim 20 wherein each projection has axially spaced sides which are shaped and arranged to closely match axially spaced sides of the recess such that the projection passes through the recess with only small clearances.

30. The header according to claim 29 wherein the axially spaced sides of the each projection are tapered outwardly and axially.

31. The header according to claim 22 wherein the leading surface and the trailing surface are substantially sides of a triangle having an angle therebetween greater than 60 degrees.

32. A crop harvesting header comprising:
a main frame structure extending across between two ends of the header across a width of the header for movement in a direction generally at right angles to the width across ground including a crop to be harvested;
a mounting assembly for carrying the main frame;
and a crop transport system for moving the cut crop toward a discharge location of the header including:
a draper having two end guide rollers and a continuous draper canvas wrapped around the guide rollers to define a top run of the canvas for carrying the cut crop;
a discharge roller immediately adjacent to and parallel to one end guide roller of the draper and arranged to receive the crop therefrom to pass over a peripheral surface of the first discharge roller;
the roller having a cylindrical surface from which the crop is to be discharged;
a stripper blade having a stripper edge at the cylindrical surface to strip the crop from the roller for discharge therefrom;
the cylindrical surface surrounding an axis of the roller with a plurality of raised projections thereon with each projection defining a raised portion having a greater radial distance from the axis than the cylindrical surface,
the projections being arranged at axially spaced locations on the cylindrical surface leaving between the projections portions of the cylindrical surface which are not raised,
the stripper edge of the stripper blade having a plurality of axially spaced recesses therein with each recess being axially aligned with a respective one of the projections and with each recess being separated from the next by a portion of the stripper edge;
each recess being shaped such that rotation of the cylindrical surface about the axis causes the corresponding projection to pass therethrough while said portions of the stripper edge are located at said portions of the cylindrical surface to guide the stripped crop from the cylindrical surface.

33. The header according to claim 32 wherein each stripper blade is inclined downwardly and away from the roller.

34. The header according to claim 32 wherein each projection is shaped in a cross-section lying in a radial plane so as to define a leading surface, a trailing surface and an apex surface at a junction between the leading edge and the trailing edge and wherein the leading surface is shaped and arranged relative to the cylindrical surface and the stripper blade such that, as the leading surface enters the respective recess through an outer surface of the blade, the leading surface defines an angle with the outer surface of the blade which is greater than 90 degrees.

35. The header according to claim 34 wherein the leading surface is shaped and arranged relative to the outer surface of the blade such that the whole or substantially the whole of the leading surface passes through the outer surface into the recess before the angle reaches ninety degrees.

36. The header according to claim 34 wherein the leading surface defines an angle relative to a radius of the axis of the roller at the apex which is greater than 30 degrees.

37. The header according to claim 34 wherein the leading surface and the trailing surface are substantially sides of a triangle having an angle therebetween greater than 60 degrees.

38. The header according to claim 34 wherein the leading surface and the trailing surface are substantially sides of a triangle having an angle therebetween of the order of 90 degrees.

39. The header according to claim 23 wherein there is provided a plurality of rows of projections with the projections of each row being axially spaced and axially aligned with the projections of the other row or rows.

40. The header according to claim 39 wherein the rows are arranged axially of the cylindrical surface.

41. The header according to claim 32 wherein each projection has axially spaced sides which are shaped and arranged to closely match axially spaced sides of the recess such that the projection passes through the recess with only small clearances.

42. The header according to claim 41 wherein the axially spaced sides of the each projection are tapered outwardly and axially.

43. The header according to claim 34 wherein the leading surface and the trailing surface are substantially sides of a triangle having an angle therebetween greater than 60 degrees.

44. A crop harvesting header comprising:
a main frame structure extending across between two ends of the header across a width of the header for movement in a direction generally at right angles to the width across ground including a crop to be harvested;
a mounting assembly for carrying the main frame;
and a crop transport system for moving the cut crop toward a discharge location of the header including:
a draper having two end guide rollers and a continuous draper canvas wrapped around the guide rollers to define a top run of the canvas for carrying the cut crop;
the canvas at one end roller having a cylindrical surface from which the crop is to be discharged;
a stripper blade having a stripper edge at the cylindrical surface to strip the crop from the roller for discharge therefrom;
the cylindrical surface surrounding an axis of the roller with a plurality of raised projections thereon with each projection defining a raised portion having a greater radial distance from the axis than the cylindrical surface,
the projections being arranged at axially spaced locations on the cylindrical surface leaving between the projections portions of the cylindrical surface which are not raised,
the stripper edge of the stripper blade having a plurality of axially spaced recesses therein with each recess being axially aligned with a respective one of the projections and with each recess being separated from the next by a portion of the stripper edge;
each recess being shaped such that rotation of the cylindrical surface about the axis causes the corresponding projection to pass therethrough while said portions of the stripper edge are located at said portions of the cylindrical surface to guide the stripped crop from the cylindrical surface.

45. The header according to claim 44 wherein each stripper blade is inclined downwardly and away from the end roller of the draper.

46. The header according to claim 44 wherein each projection is shaped in a cross-section lying in a radial plane so as to define a leading surface, a trailing surface and an apex surface at a junction between the leading edge and the trailing edge and wherein the leading surface is shaped and arranged relative to the cylindrical surface and the stripper blade such that, as the leading surface enters the respective recess through an outer surface of the blade, the leading surface defines an angle with the outer surface of the blade which is greater than 90 degrees.

47. The header according to claim 46 wherein the leading surface is shaped and arranged relative to the outer surface of the blade such that the whole or substantially the whole of the leading surface passes through the outer surface into the recess before the angle reaches ninety degrees.

48. The header according to claim 46 wherein the leading surface defines an angle relative to a radius of the axis of the roller at the apex which is greater than 30 degrees.

49. The header according to claim 46 wherein the leading surface and the trailing surface are substantially sides of a triangle having an angle therebetween greater than 60 degrees.

50. The header according to claim 46 wherein the leading surface and the trailing surface are substantially sides of a triangle having an angle therebetween of the order of 90 degrees.

51. The header according to claim 44 wherein there is provided a plurality of rows of projections at longitudinally spaced positions of the draper and each row extending transversely of the draper to define a slat thereon with the projections of each row being axially spaced and axially aligned with the projections of the other row or rows.

52. The header according to claim 44 wherein each projection has axially spaced sides which are shaped and arranged to closely match axially spaced sides of the recess such that the projection passes through the recess with only small clearances.

53. The header according to claim 52 wherein the axially spaced sides of the each projection are tapered outwardly and axially.

54. The header according to claim 46 wherein the leading surface and the trailing surface are substantially sides of a triangle having an angle therebetween greater than 60 degrees.
